(19) United States
(12) Patent Application Publication
(10) Pub. No.: US 2008/0138678 A1
(43) Pub. Date: Jun. 12, 2008

(54) Hydrogen-processing assemblies and hydrogen-producing systems and fuel cell systems including the same

(76) Inventor: Charles R. Hill, Bend, OR (US)

Correspondence Address: KOLISCH HARTWELL, P.C., 520 SW YAMHILL STREET, Suite 200, PORTLAND, OR, 97204, US

(21) Appl. No.: 11/638,076

(22) Filed: Dec. 12, 2006

(51) Int. Cl. H01M 8/00

(52) U.S. Cl. 429/19

(57) ABSTRACT

Hydrogen-processing assemblies, components of hydrogen-processing assemblies, and fuel-processing and fuel cell systems that include hydrogen-processing assemblies. The hydrogen-processing assemblies include a hydrogen-separation region housed within an enclosure. The enclosure includes a body portion having an opening and at least one flange extending adjacent the opening. The enclosure further includes an end plate positioned at least partially within the opening. The at least one flange of the body portion engages the end plate and retains the end plate within the opening. The at least one flange may retain the end plate in a position to apply compression to the hydrogen-separation region. The hydrogen-processing assemblies may further include at least one weld or other seal that secures the at least one flange to the end plate and/or defines a fluid tight interface between the body portion and the end plate.

### TECHNICAL FIELD

The present disclosure relates generally to hydrogen-processing assemblies, and more particularly to hydrogen-processing assemblies, and components thereof, for purifying hydrogen gas.

### BACKGROUND

Purified hydrogen is used in the manufacture of many products including metals, edible fats and oils, and semiconductors and microelectronics. Purified hydrogen also is an important fuel source for many energy conversion devices. For example, fuel cells use purified hydrogen and an oxidant to produce an electrical potential. Various processes and devices may be used to produce hydrogen gas. However, many hydrogen-producing processes produce an impure hydrogen stream, which may also be referred to as a mixed gas stream that contains hydrogen gas and other gases. Prior to delivering this stream to a fuel cell stack or other hydrogen-consuming device, the mixed gas stream may be purified, such as to remove at least a portion of the other gases.

A suitable mechanism for increasing the hydrogen purity of the mixed gas stream is to utilize at least one hydrogen-selective membrane to separate the mixed gas stream into a product stream and a byproduct stream. The product stream contains a greater concentration of hydrogen gas and/or a reduced concentration of one or more of the other gases than the mixed gas stream. The byproduct stream contains at least a substantial portion of one or more of the other gases from the mixed gas stream. Hydrogen purification using one or more hydrogen-selective membranes is a pressure-driven separation process, in which the one or more hydrogen-selective membranes are contained in a pressure vessel. The mixed gas stream contacts the mixed-gas surface of the membrane(s). The product stream is formed from at least a portion of the mixed gas stream that permeates through the membrane(s), and the byproduct stream is formed from at least a portion of the mixed gas stream that does not permeate through the membrane(s). The pressure vessel is typically sealed to prevent gases from entering or leaving the pressure vessel except through defined input and outlet ports or conduits.

### SUMMARY

The present disclosure is directed to hydrogen-processing assemblies, components of hydrogen-processing assemblies, and fuel-processing and fuel cell systems that include hydrogen-processing assemblies. The hydrogen-processing assemblies include a hydrogen-separation region housed within an enclosure. The enclosure includes a body portion having an opening and at least one flange extending adjacent the opening. The enclosure further includes an end plate positioned at least partially within the opening. The at least one flange of the body portion engages the end plate and retains the end plate within the opening. The at least one flange may retain the end plate in a position to apply compression to the hydrogen-separation region. The hydrogen-processing assemblies may further include at least one weld or other seal that secures the at least one flange to the end plate and/or defines a fluid tight interface between the body portion and the end plate.

### BRIEF DESCRIPTION OF THE DRAWINGS

FIG. 1 is a schematic cross-sectional view of a hydrogen-processing assembly according to the present disclosure.

FIG. 2 is a schematic cross-sectional view of a hydrogen-processing assembly according to the present disclosure that includes a hydrogen-producing region.

FIG. 3 is a schematic plan view of another hydrogen-processing assembly according to the present disclosure.

FIG. 4 is a schematic fragmentary plan view of a portion of a hydrogen-processing assembly as generally indicated in FIG. 3.

FIG. 5 is a schematic fragmentary cross-sectional view of an illustrative, non-exclusive example of an enclosure of a hydrogen-processing assembly according to the present disclosure.

FIG. 6 is a schematic fragmentary cross-sectional view of another illustrative, non-exclusive example of an enclosure of a hydrogen-processing assembly according to the present disclosure.

FIG. 7 is a schematic fragmentary cross-sectional view of another illustrative, non-exclusive example of an enclosure of a hydrogen-processing assembly according to the present disclosure.

FIG. 8 is a schematic fragmentary cross-sectional view of another illustrative, non-exclusive example of an enclosure of a hydrogen-processing assembly according to the present disclosure.

FIG. 9 is a schematic fragmentary cross-sectional view of another illustrative, non-exclusive example of an enclosure of a hydrogen-processing assembly according to the present disclosure.

FIG. 10 is a schematic fragmentary cross-sectional view of another illustrative, non-exclusive example of an enclosure of a hydrogen-processing assembly according to the present disclosure.

FIG. 11 is a schematic fragmentary cross-sectional view of another illustrative, non-exclusive example of an enclosure of a hydrogen-processing assembly according to the present disclosure.

FIG. 12 is an exploded view of an illustrative, non-exclusive example of a hydrogen-processing assembly according to the present disclosure.

FIG. 13 is a fragmentary plan view of portions of the body portion and hydrogen-separation region of the enclosure of FIG. 12.

FIG. 14 is an exploded isometric view of an illustrative, non-exclusive example of a membrane-based separation region which may be used in and/or with hydrogen-processing assemblies according to the present disclosure.

FIG. 15 is an exploded isometric view of another illustrative, non-exclusive example of a hydrogen-processing assembly according to the present disclosure.

FIG. 16 is an isometric view of another illustrative, non-exclusive example of a hydrogen-processing assembly according to the present disclosure shown without a weld between the end plate and the body portion of the enclosure.

FIG. 17 is a fragmentary cross-sectional isometric view of the hydrogen-processing assembly of FIG. 16 shown with a weld between the end plate and the body portion of the enclosure and shown with an illustrative, non-exclusive example of a hydrogen-separation region.

FIG. 18 is an exploded isometric view of the hydrogen-processing assembly of FIG. 17.

FIG. 19 is a schematic fragmentary side view of an illustrative, non-exclusive example of an illustrative hydrogen-separation region that includes a pair of separation membranes separated by a support.

FIG. 20 is an exploded isometric view of an illustrative, non-exclusive example of a hydrogen-separation region that includes a pair of separation membranes separated by a support that includes a screen structure having several screen members.

FIG. 21 is an exploded isometric view of another illustrative, non-exclusive example of a separation region having a pair of separation membranes.

FIG. 22 is an exploded isometric view of another illustrative, non-exclusive example of a separation region having a pair of separation membranes.

FIG. 23 is a schematic diagram of a fuel-processing system that includes a hydrogen-processing assembly according to the present disclosure and a source of hydrogen gas to be purified in the hydrogen-processing assembly.

FIG. 24 is a schematic diagram of a fuel-processing system that includes a hydrogen-producing fuel processor integrated with a hydrogen-processing assembly according to the present disclosure.

FIG. 25 is a schematic diagram of another fuel processor system that includes a hydrogen-producing fuel processor and an integrated hydrogen-processing assembly according to the present disclosure.

FIG. 26 is a schematic diagram of a fuel cell system that includes a hydrogen-processing assembly according to the present disclosure.

### DETAILED DESCRIPTION

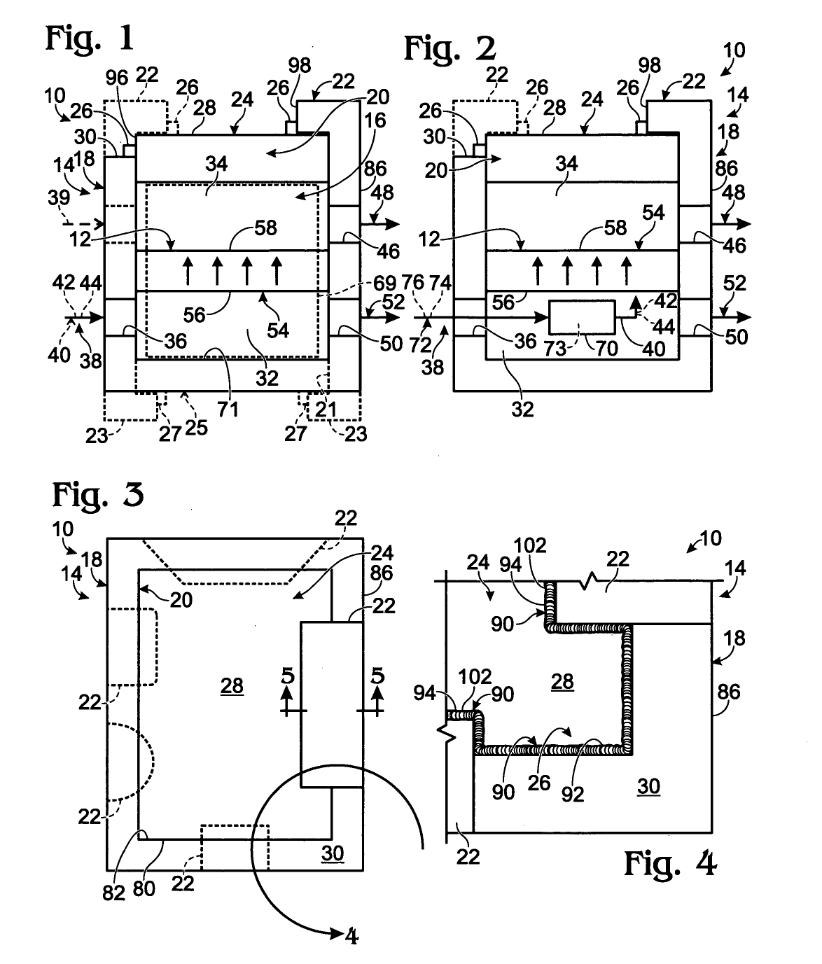

An illustrative, non-exclusive example of a hydrogen-processing assembly according to the present disclosure is schematically illustrated in cross-section in FIG. 1 and generally indicated at 10. Assembly 10 includes a hydrogen-separation region 12 and an enclosure 14. Enclosure 14 defines an internal volume 16 and includes a body portion 18 having an opening 20 and at least one flange 22 extending adjacent the opening. The enclosure also includes an end plate 24 positioned at least partially within opening 20. Flange(s) 22 engage the end plate and retain the end plate within the opening. As illustrated in FIG. 1, the flange(s) extend across at least a portion of the opening to engage an external surface 28 of the end plate. External surface 28 refers generally to the surface, or region, of the end plate that faces generally away from internal volume 16. It is within the scope of the present disclosure that the flange(s) may extend at least partially within the opening and/or may extend across a portion of the opening but be external internal volume 16. Therefore, the term “adjacent” with respect to relative position of the flange(s) with respect to opening 20 does not require nor preclude the flange from being at least partially within internal volume 16, completely external internal volume 16, and/or extending at least partially through, or across, opening 20. The flange(s) may additionally or alternatively be described as extending proximate the opening and/or extending in a position to obstruct removal of end plate 24 from the opening.

Hydrogen-processing assemblies 10 according to the present disclosure may include a seal 26 that secures the flange 22 to the end plate 24. Seal 26 may (but is not required to in all embodiments) define a fluid-tight interface between the body portion and the end plate. The sealed enclosure may be described as a sealed pressure vessel that includes defined input and output ports that define the flow paths by which gases or other fluids are delivered into and removed from the enclosure's internal volume. As illustrated, seal 26 is provided between end plate 24 and body portion 18. Where flange(s) 22 engage the end plate, seal 26 may be provided between the end plate and the flange(s). Seal 26 may (but is not required to in all embodiments) additionally or alternatively, secure the end plate in a predetermined position relative to the body portion of the enclosure, such as in a predetermined position within the opening to apply at least a predetermined amount of compression to the hydrogen-separation region within the enclosure. End plate 24 may be retained in position to apply a predetermined amount of compression to hydrogen-separation region 12 prior to the seal being applied to secure the flange(s) to the end plate. When seal 26 is applied, it may secure the end plate in this position to maintain the compression. Seal 26 may (but is not required to in all embodiments) permit the compression to be more evenly distributed across the end plate (and/or hydrogen-separation region) than when spaced-apart bolts or other fasteners are used. Though illustrated as partially extending out of opening 20, it is within the scope of the present disclosure that end plate 24 may be fully within opening 20 such that external surface 28 of end plate 24 is flush or approximately flush with a peripheral surface 30 of body portion 18. Alternatively, end plate 24 may be fully within the opening such that external surface 28 is recessed past peripheral surface 30.

Enclosure 14 includes a mixed gas region 32 and a permeate region 34. The mixed gas and permeate regions are separated by hydrogen-separation region 12. At least one input port 36 is provided, through which a fluid stream 38 is delivered to the enclosure. In the illustrative embodiment shown in FIG. 1, fluid stream 38 is indicated to be a mixed gas stream 40 that contains hydrogen gas 42 and other gases 44 that are delivered to mixed gas region 32. Hydrogen gas may be a majority component of the mixed gas stream. As somewhat schematically illustrated in FIG. 1, hydrogen-separation region 12 extends between mixed gas region 32 and permeate region 34 so that gas in the mixed gas region must pass through the hydrogen-separation region in order to enter the permeate region. As discussed in more detail herein, this may require the gas to pass through at least one hydrogen-selective membrane.

Enclosure 14 also includes at least one product output port 46, through which a permeate stream 48 is removed from permeate region 34. The permeate stream contains at least one of a greater concentration of hydrogen gas and a lower concentration of the other gases than the mixed gas stream. It is within the scope of the present disclosure that permeate stream 48 may (but is not required to) also at least initially include a carrier, or sweep, gas component, such as may be delivered through a sweep gas port 39 that is in fluid communication with the permeate region. The enclosure also includes at least one byproduct output port 50, through which a byproduct stream 52 containing at least a substantial portion of the other gases 44 is removed from the mixed gas region 32.

Hydrogen-separation region 12 includes at least one hydrogen-selective membrane 54 having a mixed gas surface 56, which is oriented for contact by mixed gas stream 40, and a permeate surface 58, which is generally opposed to surface 56. Accordingly, in the illustrated embodiment of FIG. 1, mixed gas stream 40 is delivered to the mixed gas region of the enclosure so that it comes into contact with the mixed gas surface of the one or more hydrogen-selective membranes. Permeate stream 48 is formed from at least a portion of the mixed gas stream that passes through the separation region to permeate region 34. Byproduct stream 52 is formed from at least a portion of the mixed gas stream that does not pass through the separation region. In some embodiments, byproduct stream 52 may contain a portion of the hydrogen gas present in the mixed gas stream. The separation region may (but is not required to) also be adapted to trap or otherwise retain at least a portion of the other gases, which may then be removed as a byproduct stream as the separation region is replaced, regenerated, or otherwise recharged.

In FIG. 1, streams 39, 40, 42, and 44 schematically represent that each of these streams may include more than one actual stream flowing into or out of assembly 10. For example, assembly 10 may receive plural feed streams 40, a single stream 40 that is divided into plural streams prior to contacting separation region 12, a single stream that is delivered into volume 16, etc. Accordingly, enclosure 14 may include more than one input port 36. Similarly, an enclosure 14 according to the present disclosure may include more than one sweep gas port 39, more than one product outlet port 46, and/or more than one byproduct outlet port 50.

The hydrogen-selective membranes may be formed of any hydrogen-permeable material suitable for use in the operating environment and parameters in which hydrogen-processing assembly 10 is operated. Illustrative, non-exclusive examples of suitable materials for membranes 54 are disclosed in U.S. Pat. Nos. 6,537,352 and 5,997,594, and in U.S. Provisional Patent Application No. 60/854,058, the entire disclosures of which are hereby incorporated by reference for all purposes. In some embodiments, the hydrogen-selective membranes may be formed from at least one of palladium and a palladium alloy. Illustrative, non-exclusive examples of palladium alloys include alloys of palladium with copper, silver, and/or gold. However, the membranes may be formed from other hydrogen-permeable and/or hydrogen-selective materials, including metals and metal alloys other than palladium and palladium alloys. Examples of suitable mechanisms for reducing the thickness of the membranes include rolling, sputtering and etching. A suitable etching process is disclosed in U.S. Pat. No. 6,152,995, the complete disclosure of which is hereby incorporated by reference for all purposes. Additional illustrative examples of various membranes, membrane configurations, and methods for preparing the same are disclosed in U.S. Pat. Nos. 6,221,117, 6,319,306, and 6,537,352, the complete disclosures of which are hereby incorporated by reference for all purposes.

In some embodiments, a plurality of spaced-apart hydrogen-selective membranes 54 may be used in a hydrogen-separation region 12. When present, the plurality of membranes may collectively define a membrane assembly, or membrane envelope, which is collectively indicated at 69 in FIG. 1. In such embodiments, the membrane assembly may generally extend from end plate 24 to an opposing inside surface 71 of body portion 18. Accordingly, the at least one flange 22 may effectively compress the hydrogen-separation region between the body portion and the end plate. Additionally or alternatively, in some embodiments, enclosure 14 may include a second end plate 25 positioned at least partially within a second opening 21, and at least a second flange 23 that engages and retains the second end plate within the second opening, as illustrated in dashed lines in FIG. 1. In such embodiments, flanges 22, 23 may effectively compress the hydrogen-separation region 12 (and other components that may be housed within the enclosure) between a pair of opposing end plates 24, 25. Furthermore, a second seal 27 may define a fluid-tight interface between the body portion and the second end plate.

Hydrogen purification using one or more hydrogen-selective membranes is typically a pressure-driven separation process in which the mixed gas stream is delivered into contact with the mixed gas surfaces of the membranes at a higher pressure than the gases in the permeate region of the hydrogen-separation region. Although not required to all embodiments, the hydrogen-separation region may be heated via any suitable mechanism to an elevated temperature when the hydrogen-separation region is utilized to separate the mixed gas stream into the permeate and byproduct streams. Illustrative, non-exclusive examples of suitable operating temperatures include temperatures of at least 275° C., temperatures of at least 325° C., temperatures of at least 350° C., temperatures in the range of 275-500° C., temperatures in the range of 275-375° C., temperatures in the range of 300-450° C., temperatures in the range of 350-450° C., and the like.

In some embodiments, as illustrated in FIG. 2, the hydrogen-processing assembly may, though is not required to, further include a hydrogen-producing region 70. Illustrative, non-exclusive examples of hydrogen-producing regions suitable for incorporation in hydrogen-processing assemblies 10 of the present disclosure are disclosed in U.S. patent application Ser. No. 11/263,726 and U.S. Provisional Patent Application No. 60/802,716, the complete disclosures of which are hereby incorporated by reference for all purposes. In such embodiments, the at least one flange 22 may effectively compress both the hydrogen-separation region and the hydrogen-producing region between the body portion and the end plate, or between two end plates in embodiments incorporating more than one end plate, as discussed above and schematically illustrated in FIG. 1. As a further illustrative example, the at least one flange may compress the hydrogen-separation region between the end plate and a support within the internal volume and/or body portion of the enclosure.

In embodiments incorporating a hydrogen-producing region 70, fluid stream 38 delivered to the internal volume may be in the form of one or more hydrogen-producing fluids, or feed streams, 72 that are delivered to the hydrogen-producing region 70, which may include a suitable catalyst 73 for catalyzing the formation of hydrogen gas from the feed stream(s) delivered thereto. Illustrative, non-exclusive examples of feed stream(s) 72 include water 74 and a carbon-containing feedstock 76, which (when present) may be delivered in the same or separate fluid streams.

In the hydrogen-producing region, the feed stream(s) chemically react to produce hydrogen gas therefrom in the form of mixed gas stream 40. In other words, rather than receiving mixed gas stream 40 from an external source, as in the embodiment shown in FIG. 1, hydrogen-processing assemblies 10 according to the present disclosure may optionally include a hydrogen-producing region 70 that is housed within enclosure 14 itself. This hydrogen-producing region produces mixed gas stream 40 containing hydrogen gas 42 and other gases 44 within the enclosure and this mixed gas stream is then delivered to mixed gas region 32 and separated into permeate and byproduct streams by hydrogen-separation region 12.

Illustrative, non-exclusive examples of suitable mechanisms for producing mixed gas stream 40 from one or more feed stream(s) 16 include steam reforming and autothermal reforming, in which reforming catalysts are used to produce hydrogen gas from at least one feed stream 72 containing water 74 and a carbon-containing feedstock 76. In a steam reforming process, hydrogen-producing region 70 may be referred to as a reforming region, and output, or mixed gas, stream 40 may be referred to as a reformate stream. Examples of suitable steam reforming catalysts include copper-zinc formulations of low temperature shift catalysts and a chromium formulation sold under the trade name KMA by Sud-Chemie, although others may be used. The other gases that are typically present in the reformate stream include carbon monoxide, carbon dioxide, methane, steam, and/or unreacted carbon-containing feedstock. In an autothermal reforming reaction, a suitable autothermal reforming catalyst is used to produce hydrogen gas from water and a carbon-containing feedstock in the presence of air. When autothermal reforming is used, the fuel processor further includes an air delivery assembly that is adapted to deliver an air stream to the hydrogen-producing region. Autothermal hydrogen-producing reactions utilize a primary endothermic reaction that is utilized in conjunction with an exothermic partial oxidation reaction, which generates heat within the hydrogen-producing region upon initiation of the initial hydrogen-producing reaction.

Illustrative, non-exclusive examples of other suitable mechanisms for producing hydrogen gas include pyrolysis and catalytic partial oxidation of a carbon-containing feedstock, in which case the feed stream includes a carbon-containing feedstock and does not (or does not need to) contain water. A further illustrative, non-exclusive example of a mechanism for producing hydrogen gas is electrolysis, in which case the feed stream includes water but not a carbon-containing feedstock. Illustrative, non-exclusive examples of suitable carbon-containing feedstocks include at least one hydrocarbon or alcohol. Examples of suitable hydrocarbons include methane, propane, butane, natural gas, diesel, kerosene, gasoline and the like. Illustrative, non-exclusive examples of suitable alcohols include methanol, ethanol, and polyols, such as ethylene glycol and propylene glycol. It is within the scope of the present disclosure that a hydrogen-processing assembly 10 that includes a hydrogen-producing region 70 may utilize more than a single hydrogen-producing mechanism in the hydrogen-producing region.

As illustrated somewhat schematically in FIG. 3, end plate 24 may include an outer peripheral region 80 that corresponds to an internal perimeter 82 of opening 20. In other words, end plate 24 and opening 20 may be sized and shaped such that end plate 24 fits generally within opening 20 to obstruct, or cover, the opening.

Flange(s) 22 according to the present disclosure may have any suitable size and shape such that they engage and retain end plate 24 at least partially within opening 20. As an illustrative, non-exclusive example, and as illustrated in FIGS. 1 and 2, flange(s) 22 may generally have the same thickness as an adjacent wall 86 of body portion 18; however, it is within the scope of the present disclosure that flanges(s) 22 may have a thickness that is greater than or less than the adjacent wall of the body portion. Additionally, as illustrated in FIG. 3, flange(s) 22 may have any suitable shape including, but not limited to, rectangular, trapezoidal, semi-circular, polygonal, arcuate, etc. Similarly, enclosures 14 according to the present disclosure are not limited to rectangular dimensions. Enclosures 14 may be provided in any suitable shape including, but not limited to, enclosures with polygonal cross-sections, cylindrical enclosures with circular cross-sections, etc. For example, opening 20 may include three or more sides and a flange 22 may extend adjacent at least one of the three or more sides. In some embodiments, body portion 18 may include at least one flange 22 that extends adjacent each of the three or more sides of opening 20.

FIG. 3 somewhat schematically provides an illustrative example of a body portion 18 with four sides, which define a rectilinear-shaped opening 20. The illustrative body portion also includes at least one flange 22 extending from each of the sides to extend over, or adjacent, the opening, such as to apply compression to end plate 28 (and optionally a hydrogen-separation region 12) within the assembly's internal volume. While each side, or wall portion, of an assembly's body portion may include at least one flange extending therefrom, this is not required for all assemblies according to the present disclosure.

As mentioned, assemblies 10 according to the present disclosure may include a seal 26 that secures the flange(s) to end plate 24 and which may define a fluid-tight interface between body portion 18 and the end plate. An illustrative, non-exclusive example of a seal 26 that is configured to provide such a fluid-tight interface is illustrated in FIG. 4, which is a schematic fragmentary plan view of a portion of enclosure 14 shown in FIG. 3 and including two flanges 22. As illustrated in FIG. 4, seal 26 may be in the form of a weld 90. As indicated, weld 90 provides a fluid tight seal along the entire interface of body portion 18 and end plate 24. That is, weld 90 provides a fluid tight seal between flanges 22 and end plate 24 and between walls 86 of body portion 18 and end plate 24. Accordingly weld 90 may be referred to as a seal weld 92.

Where the interface between the body portion and end plate is formed between two surfaces at an angle to one another, weld 90 may be, or be described as, a fillet weld 94, as indicated in FIG. 4. For example, in embodiments where the end plate extends partially out of the opening, as illustrated in FIG. 1, a fillet weld may be provided between peripheral surface 30 and a peripheral surface 96 of the end plate. Similarly, a fillet weld may be provided between external surface 28 of the end plate and flange edges 98, as shown in FIG. 1. Also, in embodiments where the end plate is recessed past peripheral surface 30, a fillet weld may be provided between external surface 28 of the end plate and the inside surface of body portion 18 that defines opening 20. Where weld 90 forms a fluid tight seal between flange(s) 22 and end plate 24, the weld may also be, or be described as, a lap weld 102. In embodiments where the end plate is fully within the opening such that external surface 28 is flush or approximately flush with peripheral surface 30 and the weld provides a fluid tight seal therebetween, the weld may be, or be described as, simply a seal weld 92. Other suitable forms of welds beyond those described and illustrated herein may be used and are also within the scope of the present disclosure.

In some embodiments, the fluid tight interface may be free of groove welds. That is, seal 26 may include a weld or welds 90 in forms other than groove welds. For purposes of the present disclosure, groove welds are welds that are formed between two pieces where one or both of the pieces have been prepared with a groove or grooves, a chamfer or chamfers, a notch or notches, etc. at the interface of the weld. In other words, prior to welding two pieces together, at least one of the two pieces is physically altered to provide a groove for the weld material to be deposited in. While not required to all embodiments of enclosures 14 according to the present disclosure, some enclosures 14 may be sealed with a fluid tight interface that is free of groove welds. In other words, the interface between body portion 18 and end plate 24 may need no preparation prior to sealing with a weld or welds, and a weld or weld may create a fluid tight interface without any prior preparation of the interface.

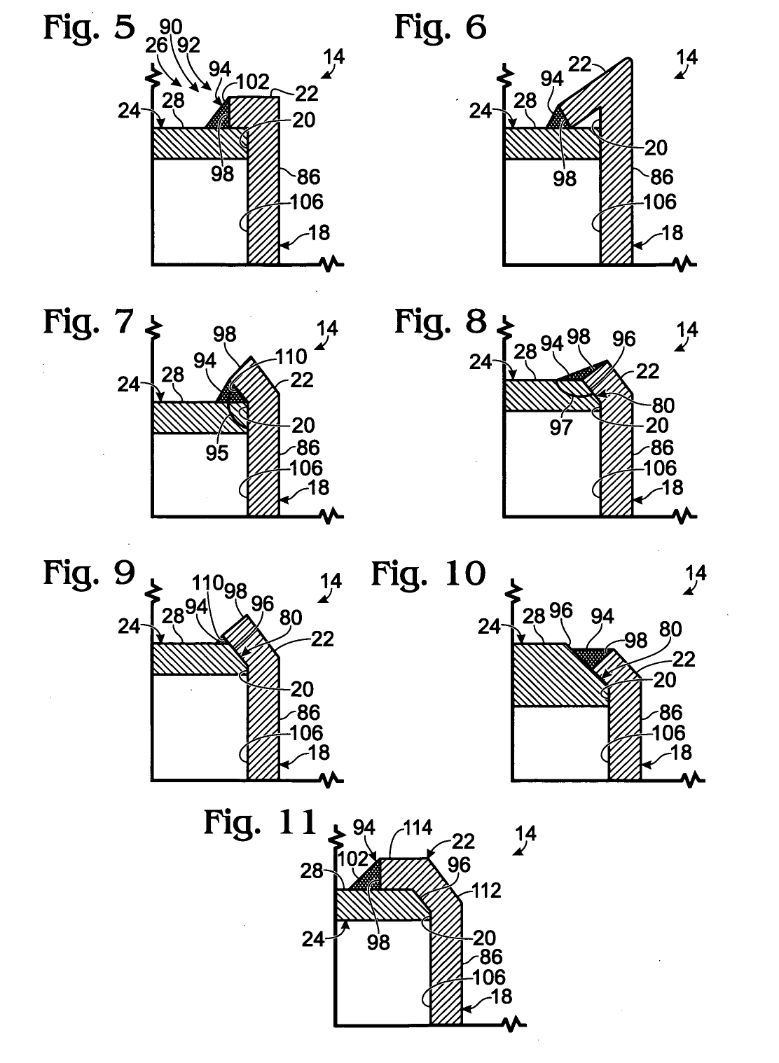

FIGS. 5-11 schematically illustrate partial cross-sectional views of illustrative, non-exclusive examples of suitable configurations for enclosures 14 according to the present disclosure. Specifically, FIGS. 5-11 illustrate various non-exclusive examples of suitable interfaces between flanges 22 and end plates 24, and seals 26 in the form of seal welds 92 and more specifically in the form of fillet welds 94. As shown, flange(s) 22 may extend adjacent opening 20 at a variety of angles from and relative to the adjacent wall 86. Also, end plate 24 may have a variety of cross-sectional shapes, including those described, illustrated, and/or incorporated herein.

As shown in FIG. 5, a flange 22 may be formed at a generally right angle to adjacent wall 86. Stated differently, flange 22 may extend adjacent opening 20 within a plane generally parallel to the opening. Stated differently again, flange 22 may extend adjacent opening 20 at a right, or ninety degree, angle relative to an inside surface 106 of adjacent wall 86 of body portion 18. Accordingly, in such embodiments, a fillet weld 94 may be formed between external surface 28 and flange edge 98, and the fillet weld may be described as lap weld 102.

FIG. 6 schematically illustrates a non-exclusive example where a flange 22 extends adjacent opening 20 at an acute angle relative to inside surface 106 of body portion 18. In such embodiments, the acute angle may be any angle between zero and ninety degrees. For example, the acute angle may be in the range of ten and eighty degrees, in the range of thirty and sixty degrees, in the range of five and forty-five degrees, in the range of fifteen and forty-five degrees, and/or may be, or may approximately be, forty-five degrees as generally illustrated in FIG. 6. In such embodiments, a fillet weld 94 may be formed between external surface 28 and flange edge 98.

FIG. 7 schematically illustrates a non-exclusive example where flange 22 at an obtuse angle, as indicated and/or measured at 95 in FIG. 7, relative to inside surface 106 of body portion 18. In such embodiments, the obtuse angle may be any angle between ninety and 180 degrees. For example, the obtuse angle may be in the range of 100 and 170 degrees, in the range of 120 and 150 degrees, in the range of 135 and 170 degrees, in the range of ninety and 135 degrees, in the range of 105 and 135 degrees, or may be, or may approximately be, 135 degrees as generally illustrated in FIG. 7. In such embodiments, a fillet weld 94 may be formed between external surface 28 and an inside face 110 of flange 22.

FIGS. 8-11 illustrate non-exclusive examples where peripheral region 80 of end plate 24 is chamfered, or otherwise angled, relative to external surface 28 of the end plate. In other words, the edge of the end plate that is engaged by flange 22 is not blocked, or squared. Rather, peripheral region 80 of end plate 24 may include at least a peripheral surface 96 that extends at an obtuse angle relative to external surface 28, as indicated and/or measured at 97 in FIG. 8. As illustrative, non-exclusive examples, the obtuse angle may be in the range of 100 and 170 degrees, in the range of 120 and 150 degrees, or may be, or may approximately be, 135 degrees, as generally illustrated in FIGS. 8-11.

FIGS. 8-11 illustrate non-exclusive examples where flange 22 extends adjacent opening 20 at an obtuse angle relative to inside surface 106, and end plate 24 includes peripheral surface 96 at a corresponding obtuse angle relative to external surface 28 such that flange 22 is generally flush with peripheral surface 96.

The non-exclusive example illustrated in FIG. 8 includes a flange 22 that terminates at, or at least approximately at, external surface 28. Accordingly, a fillet weld 94 may be formed between external surface 28 and flange edge 98.

The non-exclusive example illustrated in FIG. 9 includes a flange 22 that extends, or terminates, past external surface 28. Stated differently, flange 22 may be longer than peripheral surface 96 of the end plate and thereby may project beyond, or outward from, the end plate. Accordingly, a fillet weld 94 may be formed between external surface 28 and inside face 110 of the flange.

The non-exclusive example illustrated in FIG. 10 includes a flange 22 that terminates prior to external surface 28, or along peripheral surface 96. Stated differently, flange 22 may be shorter than peripheral surface 96 of the end plate. Accordingly, at least a portion of fillet weld 94 may be formed between peripheral surface 96 and flange edge 98.

The non-exclusive example illustrated in FIG. 11 includes a flange 22 that includes a first portion 112, which extends adjacent opening 20 at an obtuse angle relative to inside surface 106, and a second portion 114, which extends from the first portion within a plane generally parallel to the opening. In other words, the first portion of the flange is at an angle that (generally) corresponds to the angle of peripheral surface 96 relative to external surface 28, and the second portion extends from the first portion so that it is generally flush with and engages external surface 28. Accordingly, a fillet weld 94 may be formed between external surface 28 and flange edge 98, and may be described as a lap weld 102.

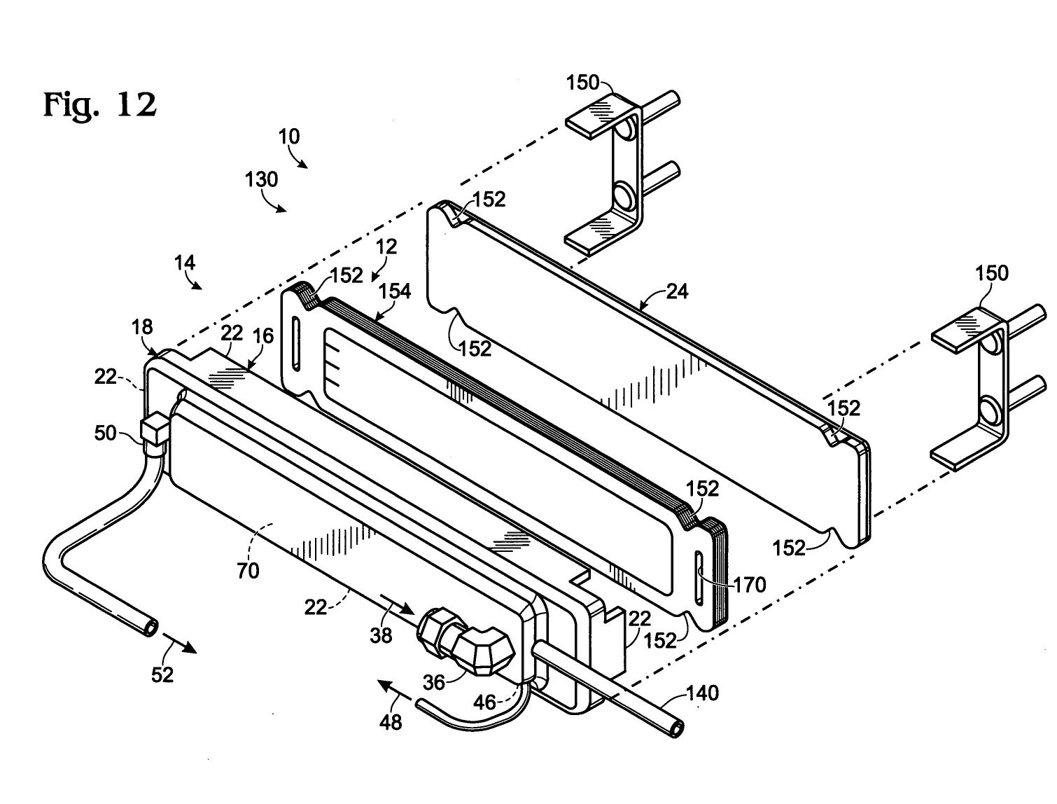

FIGS. 12-18 illustrate various illustrative non-exclusive exemplary embodiments of hydrogen-processing assemblies 10 according to the present disclosure. Assemblies 10 according to the present disclosure, while illustrated in FIGS. 12-18 with like numerals corresponding to the various components and portions thereof, etc. introduced above, are not limited to such illustrated configurations. For example, the shape and location of various components, including, but not limited to, the input and output ports, the hydrogen-separation region, the membrane assemblies within the hydrogen-separation region, the hydrogen-producing region (if any), the number and configuration of flanges, etc. are not limited to the configurations illustrated.

In FIG. 12, a suitable construction for a hydrogen-processing assembly 10, including a hydrogen-separation region 12 and a hydrogen-producing region 70 housed within an enclosure 14, is shown in an unassembled, exploded condition, and generally indicated at 130. As shown in FIG. 12, the enclosure of assembly 130 includes an end plate 24 and a body portion 18 with flanges 22. In FIG. 12, flanges 22 are illustrated in an unassembled, or unbent, configuration. Accordingly, during assembly of assembly 130, hydrogen-separation region 12 is positioned in internal volume 16, end plate 24 is positioned at least partially within the opening to the body portion, and flanges 22 are then bent or otherwise caused to engage and retain the end plate within the opening. Then, a seal weld may be applied at the interface of the body portion and the end plate to create a fluid tight interface. As discussed, it is within the scope of the present disclosure that the flanges may retain the end plate in a position where a suitable amount of compression is applied to the hydrogen-separation region within the enclosure, such as to provide and/or maintain internal seals and/or flow paths within a membrane assembly of the hydrogen-separation region.

The non-exclusive illustrative example of enclosure 14 shown in FIG. 12 further includes an input port 36 for receiving a feed stream for delivery to hydrogen-producing region 70, a product output port 46 for removal of the hydrogen-rich permeate stream, and a byproduct output port 50 for removal of byproduct gases. The illustrated enclosure also includes an access port 140 for loading and removing catalyst from the hydrogen-producing region; however, assemblies according to the present disclosure are not required to include a catalyst access port. During use of illustrated assembly 130, to produce and/or purify hydrogen gas, port 140 may be capped off or otherwise sealed.

Enclosure 130 is also illustrated as including optional mounts 150, which may be used to position the enclosure 14 with respect to other components of a hydrogen generation system and/or fuel cell system, etc.

As shown in FIG. 13, body portion 18 may include at least one projection, or guide, 146 that extends into internal volume 16 to align or otherwise position the hydrogen-separation region within the enclosure. In FIG. 13, a pair of guides 146 is illustrated, but it is within the scope of the present disclosure that no guides, one guide, or more than two guides may be utilized. When more than one guide is utilized, the guides may have the same or different sizes, shapes, and/or relative orientations within the enclosure.

As also shown in FIGS. 12 and 13, the hydrogen-separation region 12 of the illustrated, non-exclusive embodiment is in the form of a membrane assembly 154 that includes recesses 152 that are sized to receive the guides 146 of the body portion when the membrane assembly is inserted into internal volume 16. Stated differently, the recesses on the membrane assembly are designed to align the guides that extend into the enclosure's internal volume to position the membrane assembly in a selected orientation within the compartment. Accordingly, the body portion may be described as providing alignment guides for the membrane assembly. In FIG. 12, it can be seen that end plate 24 may also include recesses 152. The illustrated guides and recesses are not required to all purification regions, enclosures, and/or membrane assemblies according to the present disclosure.

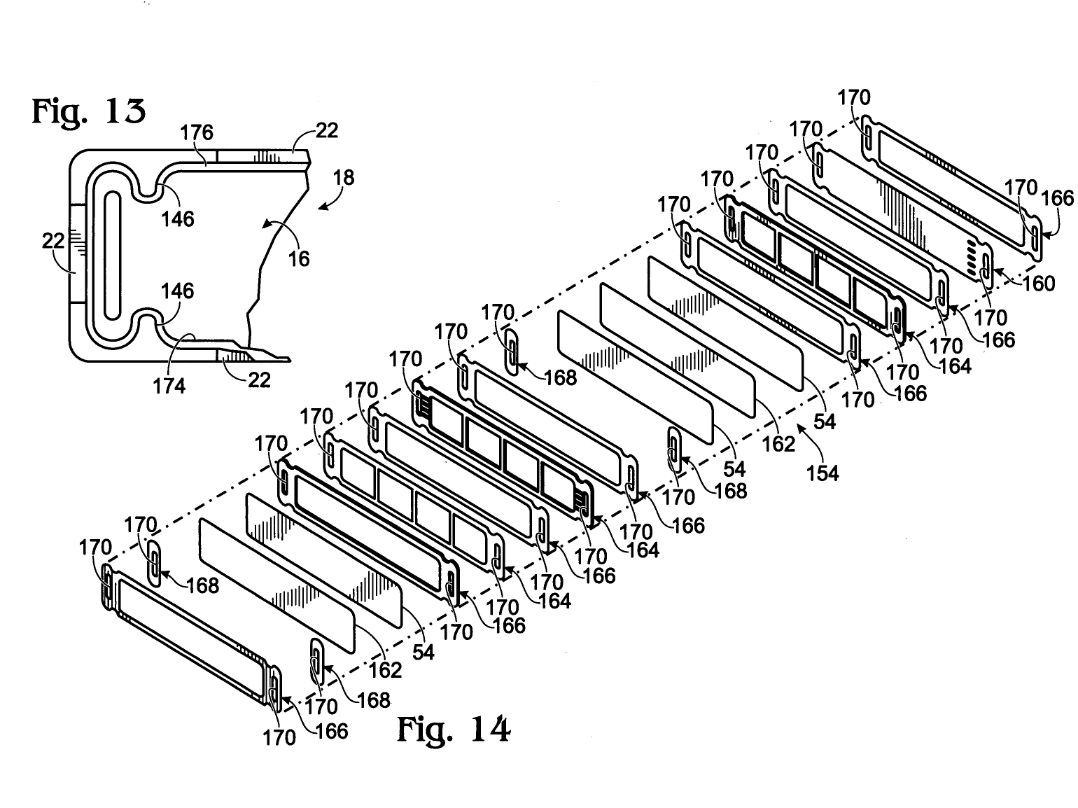

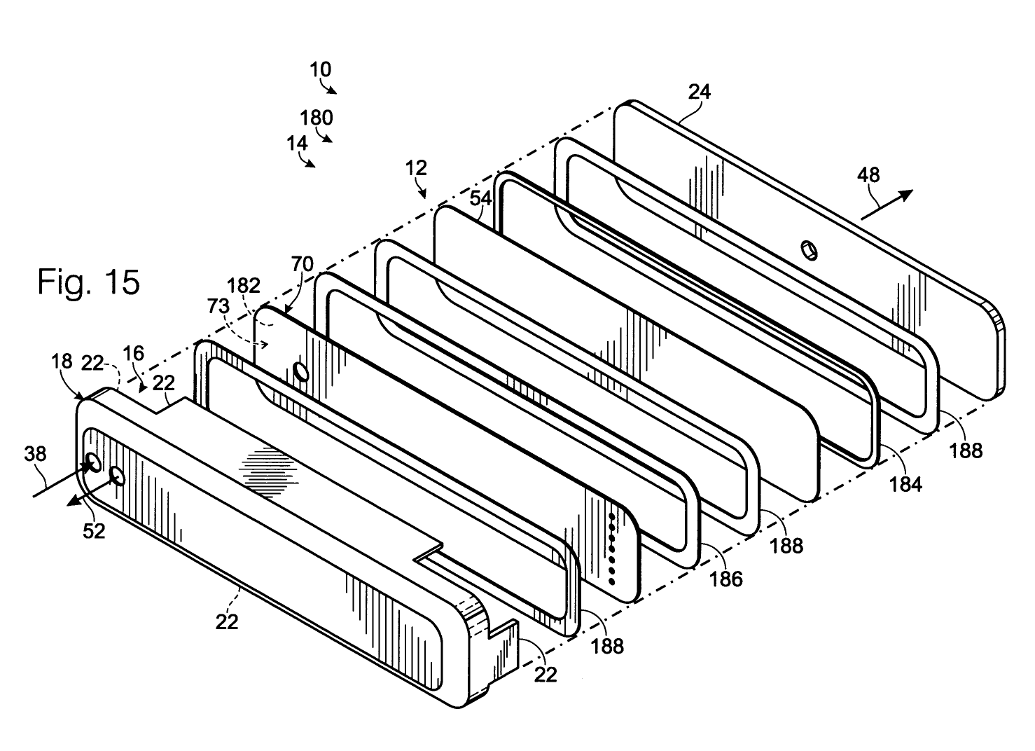

An illustrative, non-exclusive example of a suitable construction for membrane assembly 154 is shown in FIG. 14. As shown, membrane assembly 154 includes a plurality of hydrogen-selective membranes 54. Also shown are a catalyst plate 160 and various porous membrane supports 162, support plates, or frames, 164, and sealing gaskets 166. In application, hydrogen gas that permeates through the membranes may flow into the internal volume of the enclosure around membrane assembly 154 (and thereafter be removed from the internal compartment through outlet port 46). In FIG. 14, it can be seen that the membrane assembly includes sealing gaskets 168 that extend proximate the membranes, but not around the perimeters of the membranes, to provide seals for the gas distribution conduits 170 (shown in FIGS. 12 and 14) that extend through the membrane assembly and which provide respectively flow paths for the mixed gas and byproduct streams through the membrane assembly.

As somewhat schematically illustrated in FIG. 13, the membrane assembly does not seal against an internal perimeter 174 of the internal volume. Instead, a gas passage, or channel, 176 exists between membrane assembly 154 and the internal perimeter 174. The size of passage 176 may vary within the scope of the present disclosure, and may be smaller than is depicted for the purpose of illustration. The permeated hydrogen gas may flow through this channel and be withdrawn from the enclosure through the product output port.

The illustrated membrane assembly 154 includes three membranes, with two of the membranes oriented as opposed membrane pairs that define a common permeate region therebetween, and the other membrane positioned opposed to an end plate of the shell. Such a pair of opposed membranes may (but is not required to) be described as a membrane envelope. Membrane assemblies 150 that are used in hydrogen-processing assemblies 10 according to the present disclosure may include fewer or more membranes, and optionally fewer or more membrane envelopes, than shown in this illustrative, non-exclusive example.

Another illustrative non-exclusive exemplary embodiment of a hydrogen processing assembly 10 that includes a hydrogen-purification region 12 and a hydrogen-producing region 70 housed within an enclosure 14 is shown in FIG. 15 in an unassembled, exploded condition, and generally indicated at 180. Hydrogen-producing region 70 may include a suitable catalyst 73 that is adapted to catalyze the steam reforming process and which may be referred to as a steam reforming catalyst. Hydrogen-separation region 12 includes at least one hydrogen-selective membrane 54 that is supported within the enclosure and positioned to receive the mixed gas stream produced by the reforming reaction and to divide this stream into a byproduct stream 52 and a hydrogen-rich permeate stream from which product hydrogen stream 48 is formed. Also shown is a support 184 for membrane 54 and various support plates and sealing gaskets 186 and 188.

In FIG. 15, flanges 22 are illustrated in an unassembled, or unbent, configuration. Accordingly, during assembly of assembly 180, hydrogen-producing region 70 and hydrogen-separation region 12 are positioned in internal volume 16, end plate 24 is positioned at least partially within the opening to the body portion, and flanges 22 are then bent or otherwise caused to engage and retain the end plate within the opening. Then, a seal weld may be applied at the interface of the body portion and the end plate to create a fluid tight interface. As discussed, it is within the scope of the present disclosure that the flanges may retain the end plate in a position where a suitable amount of compression is applied to the hydrogen-separation region within the enclosure, such as to provide and/or maintain internal seals and/or flow paths within a membrane assembly of the hydrogen-separation region.

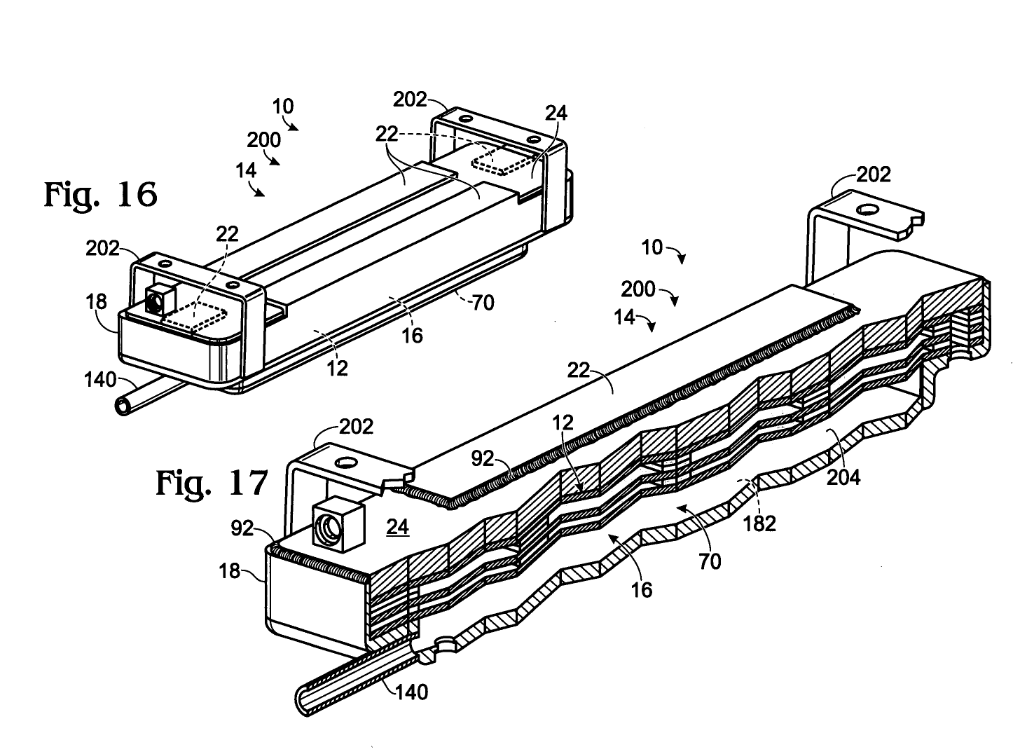

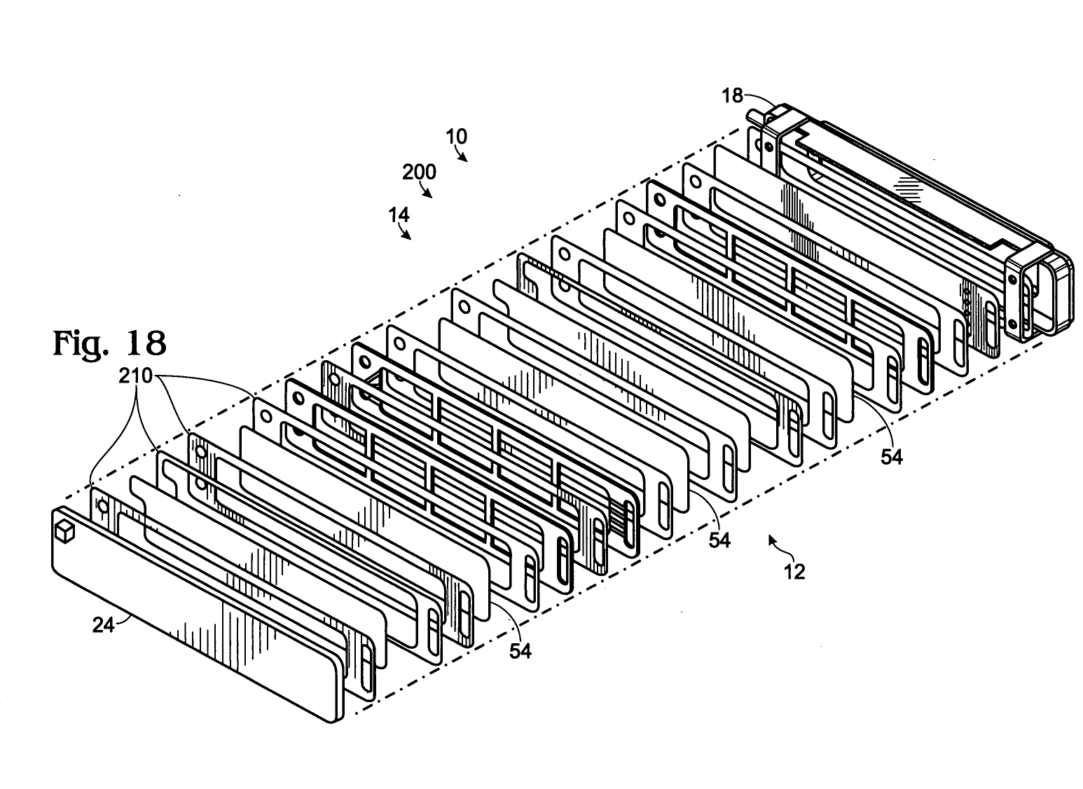

Another illustrative, non-exclusive example of a suitable configuration for a hydrogen-processing assembly 10 that includes a sealed enclosure 14 that contains a hydrogen-producing region 70 and a hydrogen-purification region 12 is shown in FIGS. 16-18, and is generally indicated at 200. The enclosure 14 is formed, in the illustrated example, from a body portion 18 having two flanges 22 and an end plate 24 that define an internal volume 16 into which the hydrogen-producing region and the purification region is housed. The illustrated elongate shape of the shell, and corresponding hydrogen-producing region 70, is not required, and other shapes and configurations may be used without departing from the scope of the present disclosure. In FIGS. 16 and 17, optional mounts 202 are shown projecting from the enclosure. In FIG. 16, additional flanges 22 are indicated in dashed lines to schematically indicate that the depicted enclosure may (but is not required to) include more than two flanges.

Similar to the illustrative examples of FIGS. 12-15, the enclosure is a sealed enclosure, in that the body portion and the end plate are seal welded after assembly of the internal components contained therewithin, as indicated at 92. For illustration purposes, the enclosure is depicted without a seal weld in FIG. 16 and with seal weld 92 in FIG. 17.

In FIGS. 16-18, and as perhaps best seen in FIG. 17, hydrogen-producing region 70 includes a catalyst region, or compartment, 204 that is sized to receive a sufficient quantity of the catalyst, such as reforming catalyst 182, for the hydrogen-generating reaction performed in the hydrogen-producing region. As perhaps best seen in FIG. 16, the hydrogen-producing region may be in communication with an access port 140. The illustrative example of an access port shown in FIG. 16 extends linearly from the catalyst region within the plane of the catalyst region and parallel to the long axis of the catalyst region. Such a construction, in which the access port does not include an elbow or other turn, is not required but may promote easier loading and unloading (i.e., removal) of the catalyst. For example, the linear extension of the access port enables catalyst to be poured into the catalyst region, or bed, through the access port and even permits the introduction of a rod or other member to compress or otherwise distribute or position the catalyst within the region.

As indicated in FIGS. 17 and 18, and as perhaps best seen in FIG. 18, enclosure 14 contains a hydrogen-separation region 12 that includes at least one hydrogen-selective membrane. As illustrated, the hydrogen-separation region includes a membrane assembly with a plurality of hydrogen-selective membranes 54. The membranes are supported in spaced-apart relationships relative to each other, with various gaskets and spacers being utilized to define flow paths between the membranes for the mixed gas (or reformate) stream, the streams containing purified hydrogen gas that has permeated through one of the membranes, and streams containing the portion of the mixed gas stream that has not permeated through the membranes and which will form a byproduct stream. As illustrated, the hydrogen-separation region 12 includes three hydrogen-selective membranes that are spaced-apart from each other by various gaskets, screens or other porous supports, frames and the like. It is within the scope of the present disclosure that more or less membranes, and corresponding supports, plates, gaskets, etc., may be used without departing from the scope of the present disclosure. For example, the inclusion of additional membranes may increase the recovery of hydrogen gas from the mixed gas stream that is produced in the hydrogen-producing region.

As illustrated, the plates and gaskets are sized with asymmetrical shapes so that these components may only be located in the housing in a predetermined configuration. This is not required, but it may assist in assembly of the components because they cannot be inadvertently positioned in the housing in a backwards or upside-down configuration. In the illustrative example of a suitable asymmetrical shape, a corner region 210 of the various components within the shell has a different shape than the other corner regions, with this difference being sufficient to permit that corner to be only inserted into one of the corresponding corner regions of the enclosure's internal volume. Accordingly, the enclosure may be described as being keyed, or indexed, to define the orientation of the gaskets, frames, supports and similar components that are stacked therein.

It is within the scope of the present disclosure that the hydrogen-producing hydrogen-processing assemblies 10 that have been illustrated and/or described with respect to FIGS. 12-18 may be formed without the hydrogen-producing region. In such an embodiment, the hydrogen-processing assembly will receive, rather than produce, mixed gas stream 40, and the enclosure may optionally be formed without the region that otherwise would contain the hydrogen-producing region. Similarly, it is within the scope of the present disclosure that the illustrative, non-exclusive examples may utilize other configurations for the body portion, flange(s), hydrogen-separation region, hydrogen-selective membranes, membrane assembly (when present), and the like without departing from the scope of the present disclosure.

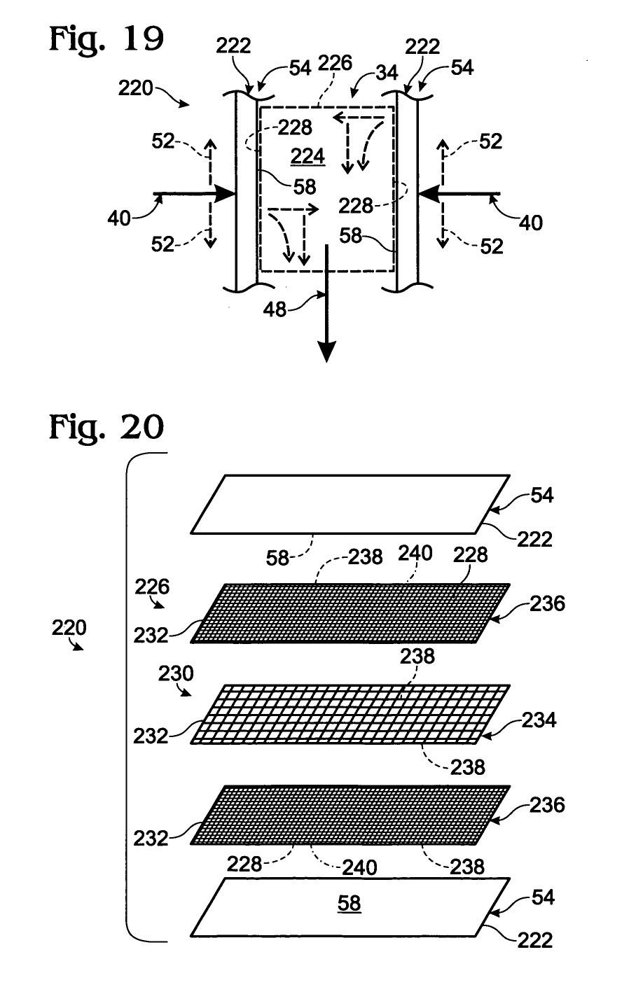

Turning now to FIG. 19, an example of a membrane envelope is shown that may be incorporated into hydrogen-separation regions of hydrogen-processing assemblies 10 according to the present disclosure, and is generally indicated at 220. That is, one or more membrane envelopes may make up or be used in membrane assemblies of hydrogen-separation regions according to the present disclosure. A membrane envelope, or membrane pairs, may take a variety of suitable shapes, such as planar envelopes and tubular envelopes. Similarly, the membranes may be independently supported, such as with respect to a body portion of an end plate or around a central passage. The membranes forming the envelope may be two separate membranes, or may be a single membrane folded, roiled or otherwise configured to define two membrane regions, or surfaces, 222 with permeate surfaces 58 that are oriented toward each other to define a conduit 224 therebetween from which the hydrogen-rich permeate gas may be collected and withdrawn. Conduit 224 may itself form permeate region 34, or an enclosure according to the present disclosure may include a plurality of membrane envelopes 220 and corresponding conduits 224 that collectively define permeate region 34. Illustrative, non-exclusive examples of membrane envelopes are disclosed in the references that have been incorporated by reference herein.

To support the membranes against high feed pressures, a support 226 may be used. Support 226 may enable gas that permeates through membranes 54 to flow therethrough. Support 226 includes surfaces 228 against which the permeate surfaces 58 of the membranes are supported. In the context of a pair of membranes forming a membrane envelope, support 226 may also be described as defining harvesting conduit 224. In conduit 224, permeated gas preferably may flow both transverse and parallel to the surface of the membrane through which the gas passes, such as schematically illustrated in FIG. 19. The permeate gas, which has at least one of a greater concentration of hydrogen gas and a lower concentration of the other gases than the mixed gas stream, may then be harvested or otherwise withdrawn from the envelope to form hydrogen-rich permeate stream 48. Because the membranes lie against the support, it is preferable that the support does not obstruct the flow of gas through the hydrogen-selective membranes. The gas that does not pass through the membranes forms one or more byproduct streams 52, as schematically illustrated in FIG. 19.

An illustrative, non-exclusive example of a suitable support 226 for membrane envelopes 220 is shown in FIG. 20 in the form of a screen structure 230. Screen structure 230 includes plural screen members 232. In the illustrated embodiment, the screen members include a coarse mesh screen 234 sandwiched between fine mesh screens 236. It should be understood that the terms “fine” and “coarse” are relative terms. In some embodiments, the outer screen members are selected to support membranes 54 without piercing the membranes and without having sufficient apertures, edges or other projections that may pierce, weaken or otherwise damage the membrane under the operating conditions with which assembly 10 is operated. Some embodiments of screen structure 230 may use a relatively coarser inner screen member to provide for enhanced, or larger, parallel flow conduits, although this is not required to all embodiments. In other words, the finer mesh screens may provide better protection for the membranes, while the coarser mesh screen may provide better flow generally parallel to the membranes, and in some embodiments may be selected to be stiffer, or less flexible, than the finer mesh screens.

During fabrication of the membrane envelopes, adhesive may (but is not required to) be used to secure membranes 54 to the screen structure and/or to secure the components of screen structure 230 together, as discussed in more detail in U.S. Pat. No. 6,319,306, the entire disclosure of which is hereby incorporated for all purposes. For purposes of illustration, adhesive is generally indicated in dashed lines at 238 in FIG. 20. An example of a suitable adhesive is sold by 3M under the trade name SUPER 77. The adhesive may be at least substantially, if not completely, removed after fabrication of the membrane envelope so as not to interfere with the permeability, selectivity and flow paths of the membrane envelopes. An example of a suitable method for removing adhesive from the membranes and/or screen structures or other supports is by exposure to oxidizing conditions prior to initial operation of assembly 10. The objective of the oxidative conditioning is to burn out the adhesive without excessively oxidizing the membrane. A suitable procedure for such oxidizing is disclosed in the above-incorporated patent. It is also within the scope of the present disclosure that the screen members, when utilized, may be otherwise secured together, such as by sintering, welding, brazing, diffusion bonding and/or with a mechanical fastener. It is also within the scope of the present disclosure that the screen members, when utilized, may not be coupled together other than by being compressed together in the hydrogen-separation region of a hydrogen-processing assembly.

Supports 226, including screen structure 230, may (but are not required to) include a coating 240 on the surfaces that engage membranes 54, such as indicated in dash-dot lines in FIG. 20. Examples of suitable coatings are disclosed in U.S. Pat. No. 6,569,227, incorporated above.

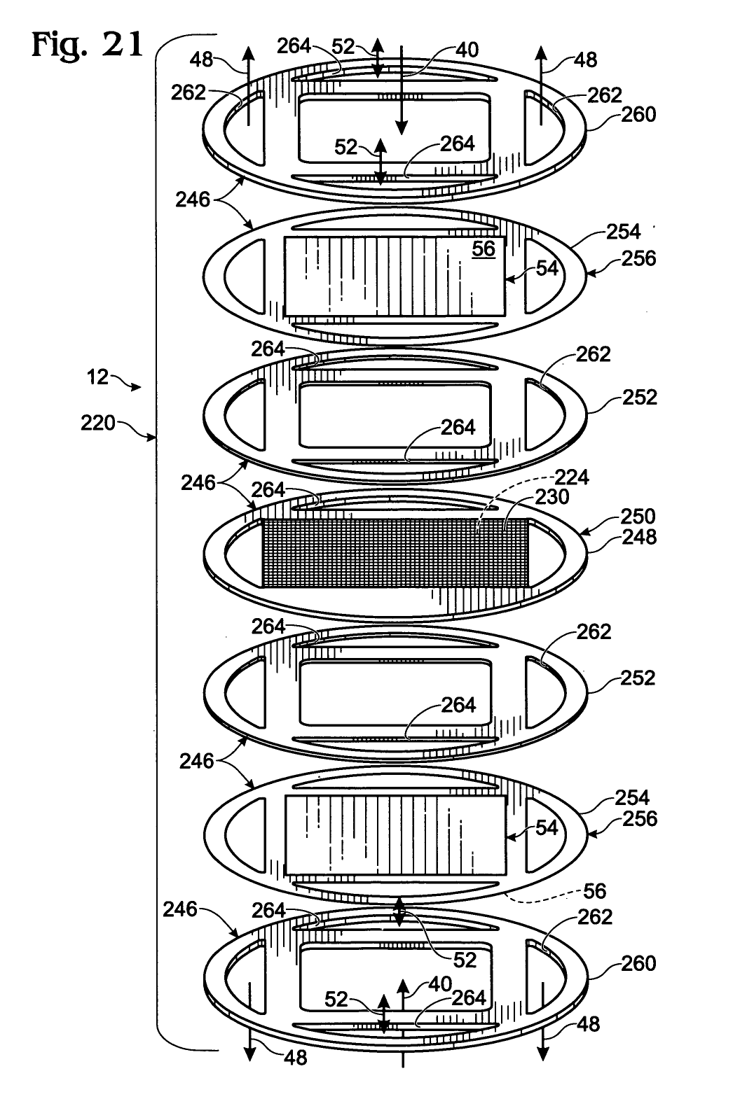

In some embodiments, the screen structure and membranes that are incorporated into a membrane envelope 220 may include frame members 246, or plates, that are adapted to seal, support and/or interconnect the membrane envelopes. An illustrative example of suitable frame members 246 is shown in FIG. 21. As shown, screen structure 230 fits within a frame member 246 in the form of a permeate frame 248. The screen structure and frame 248 may collectively be referred to as a screen plate or permeate plate 250. When screen structure 230 includes expanded metal members, the expanded metal screen members may either fit within permeate frame 248 or extend at least partially over the surface of the frame. Additional examples of frame members 246 include supporting frames, feed plates and/or gaskets. These frames, gaskets or other support structures may also define, at least in part, the fluid conduits that interconnect the membrane envelopes in an embodiment of separation region 12 that contains two or more membrane envelopes. Illustrative, non-exclusive examples of suitable gaskets are flexible graphite gaskets, including those sold under the trade name GRAFOIL™ by Union Carbide, although other materials may be used, such as depending upon the operating conditions under which assembly 10 is used.

Continuing the above illustration of exemplary frame members 246, permeate gaskets 252 may be attached to permeate frame 248, for example by using another thin application of adhesive. Each membrane 54 may be fixed to a frame member 246, such as a metal frame 254, for instance by ultrasonic welding or another suitable attachment mechanism. The membrane-frame assembly may, but is not required to be, attached to screen structure 230 using adhesive. Other examples of attachment mechanisms that achieve gas-tight seals between plates forming membrane envelope 200, as well as between the membrane envelopes, include one or more of brazing, gasketing, and welding. The membrane and attached frame may collectively be referred to as a membrane plate 256. Feed plates, or gaskets, 260 are optionally attached to plates 256, such as by using another thin application of adhesive. The resulting membrane envelope 220 is then positioned within internal volume 16, such as by a suitable mount. Optionally, two or more membrane envelopes may be stacked or otherwise supported together within volume 16.

It is within the scope of the present disclosure that the various frames discussed herein do not all need to be formed from the same materials and/or that the frames may not have the same dimensions, such as the same thicknesses. For example, the permeate and feed frames may be formed from stainless steel or another suitable structural member, while the membrane plate may be formed from a different material, such as copper, alloys thereof, and other materials discussed in the above-incorporated patents and applications. Additionally or alternatively, the membrane plate may, but is not required to be, thinner than the feed and/or permeate plates.

For purposes of illustration, an illustrative, non-exclusive example of a suitable geometry of fluid flow through membrane envelope 200 is described with respect to the embodiment of envelope 220 shown in FIG. 21. As shown, mixed gas stream 40 is delivered to the membrane envelope and contacts the outer surfaces 56 of membranes 54. The hydrogen-rich permeate gas that permeates through the membranes enters harvesting conduit 224. The harvesting conduit is in fluid communication with conduits 262 through which the permeate stream may be withdrawn from the membrane envelope. The portion of the mixed gas stream that does not pass through the membranes flows to a conduit 264 through which this gas may be withdrawn as byproduct stream 52. In FIG. 21, a pair of conduits 264 are shown to illustrate that any of the conduits described herein may alternatively include more than one fluid passage. The arrows used to indicate the flow of streams 48 and 52 have been schematically illustrated. It is within the scope of the disclosure that the direction of flow through conduits 262 and 264 may vary from that shown in FIG. 21, such as depending upon the configuration of a particular membrane envelope 220, membrane module and/or assembly 10.

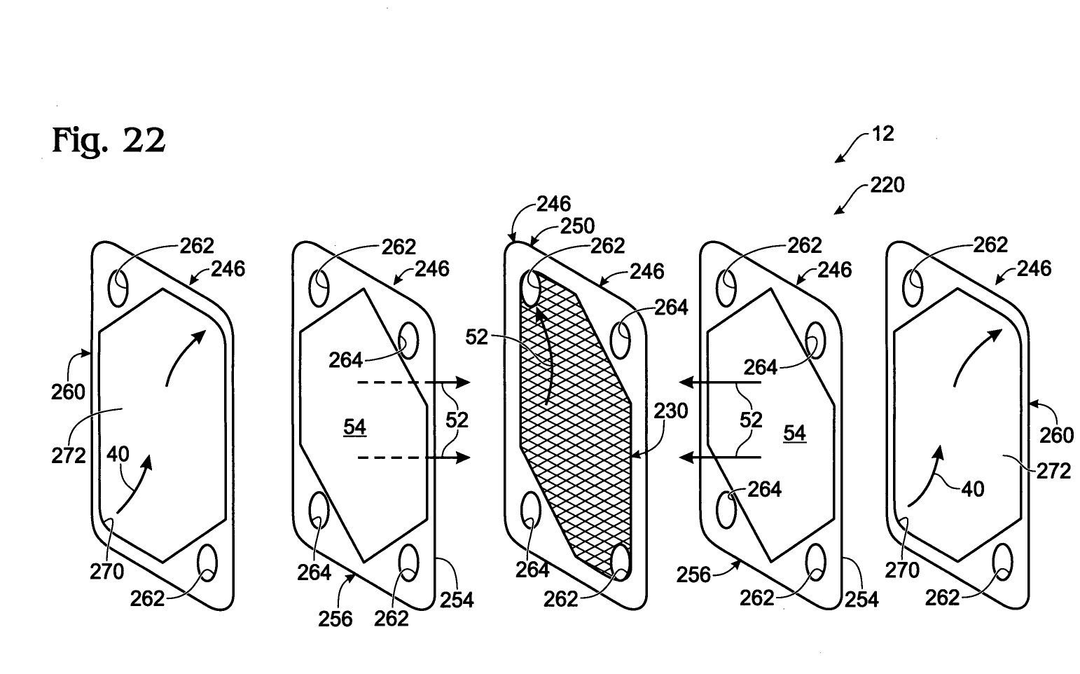

In FIG. 22, another illustrative, non-exclusive example of a suitable membrane envelope 220 that may be used in hydrogen-separation regions 12 is shown. To graphically illustrate that enclosure 14 may have a variety of configurations, envelope 220 is shown having a generally rectangular configuration. The envelope of FIG. 22 also provides another example of a membrane envelope having a pair of byproduct conduits 264 and a pair of hydrogen conduits 262. As shown, envelope 220 includes feed, or spacer, plates 260 as the outermost frames in the envelope. Generally, each of plates 260 includes a frame 270 that defines an inner open region 272. Each inner open region 272 couples laterally to conduits 264. Conduits 262, however, are closed relative to open region 272, thereby isolating hydrogen-rich stream 52. Membrane plates 256 lie adjacent and interior to plates 260. Membrane plates 256 each include as a central portion thereof a hydrogen-selective membrane 54, which may be secured to an outer frame 254, which is shown for purposes of graphical illustration. In plates 256, all of the conduits are closed relative to membrane 54. Each membrane lies adjacent to a corresponding one of open regions 272, i.e., adjacent to the flow of mixed gas arriving to the envelope. This provides an opportunity for hydrogen gas to pass through the membrane, with the non-permeating gases, i.e., the gases forming byproduct stream 52, leaving open region 272 through conduit 264. Screen plate 250 is positioned intermediate membranes 54 and/or membrane plates 256, i.e., on the interior or permeate side of each of membranes 54. Screen plate 250 includes a screen structure 230 or another suitable support. Conduits 264 are closed relative to the central region of screen plate 250, thereby isolating the byproduct stream 52 and mixed gas stream 40 from hydrogen-rich stream 48. Conduits 262 are open to the interior region of screen plate 250. Hydrogen gas, having passed through the adjoining membranes 54, travels along and through screen structure 230 to conduits 262 and eventually to an output port as the hydrogen-rich stream 48.

An illustrative, non-exclusive example of a hydrogen-processing assembly 10 that is adapted to receive mixed gas stream 40 from a source of hydrogen gas to be purified is schematically illustrated in FIG. 23. As shown, illustrative, non-exclusive examples of hydrogen sources are indicated generally at 302 and include a hydrogen-producing fuel processor 300 and a hydrogen storage device 306. In FIG. 23, a fuel processor is generally indicated at 300, and the combination of a fuel processor and a hydrogen-purification device, or hydrogen-processing assembly 10, may be referred to as a hydrogen-producing fuel-processing system 303. Also shown in dashed lines at 304 is a heating assembly, which may be provided to provide heat to assembly 10 and may take a variety of forms. Fuel processor 300 may take any suitable form including, but not limited to, the various forms of hydrogen-producing region 70 discussed above. It should be understood that the schematic representation of fuel processor 300 is meant to include any associated heating assemblies, feedstock delivery systems, air delivery systems, feed stream sources or supplies, etc. Illustrative, non-exclusive examples of suitable hydrogen storage devices 306 include hydride beds and pressurized tanks.

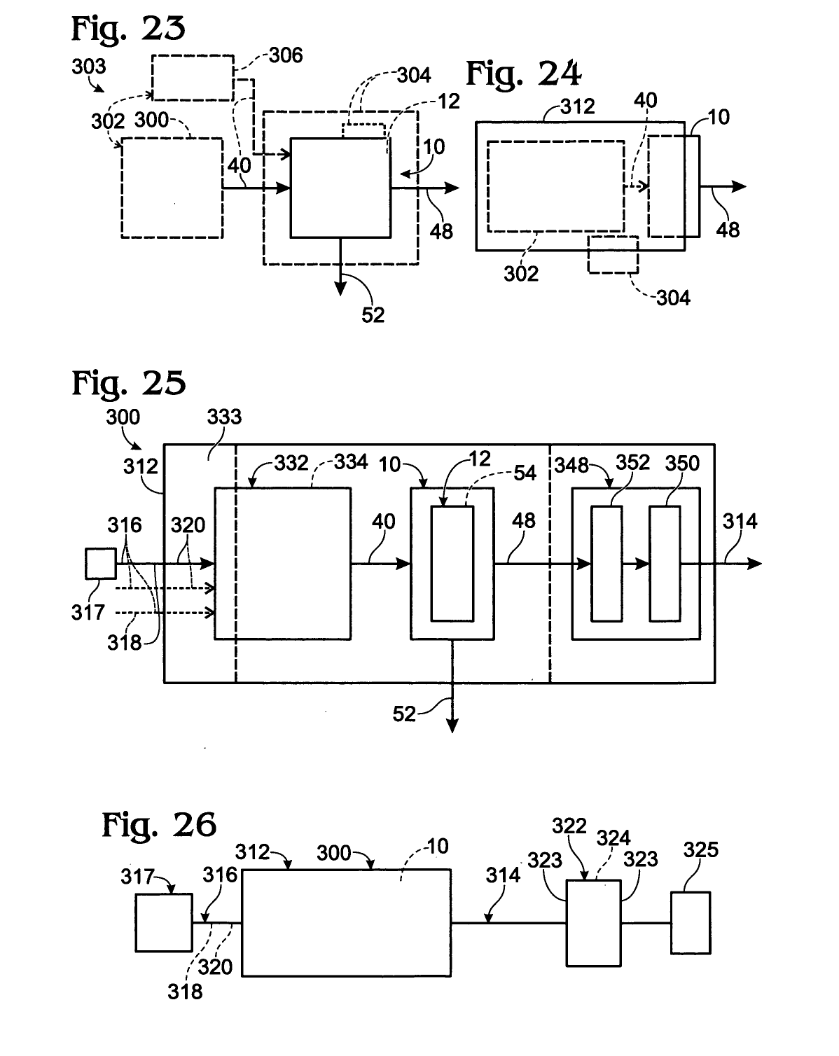

Fuel processors are often operated at elevated temperatures and/or pressures. As a result, it may be desirable to at least partially integrate hydrogen-processing assembly 10 with fuel processor 300, as opposed to having assembly 10 and fuel processor 300 connected by external fluid transportation conduits. An example of such a configuration is shown in FIG. 24, in which the fuel processor includes a shell or housing 312, which device 10 forms a portion of and/or extends at least partially within. In such a configuration, fuel processor 300 may be described as including device 10. Integrating the fuel processor or other source of mixed gas stream 40 with hydrogen-processing assembly 10 enables the devices to be more easily moved as a unit. It also enables the fuel processing system's components, including assembly 10, to be heated by a common heating assembly and/or for at least some, if not all, of the heating requirements of assembly 10 to be satisfied by heat generated by processor 300.

As discussed, fuel processor 300 is any suitable device that produces a mixed gas stream containing hydrogen gas, and preferably a mixed gas stream that contains a majority of hydrogen gas. For purposes of illustration, the following discussion will describe fuel processor 300 as being adapted to receive a feed stream 316 containing a carbon-containing feedstock 318 and water 320, as shown in FIG. 25. However, it is within the scope of the present disclosure that the fuel processor 300 may take other forms, and that feed stream 316 may have other compositions, such as containing only a carbon-containing feedstock or only water.

Feed stream 316 may be delivered to fuel processor 300 via any suitable mechanism. A single feed stream 316 is shown in FIG. 25, but it should be understood that more than one stream 316 may be used and that these streams may contain the same or different components. When the carbon-containing feedstock 318 is miscible with water, the feedstock may be delivered with the water component of feed stream 316, such as shown in FIG. 25. When the carbon-containing feedstock is immiscible or only slightly miscible with water, these components may be delivered to fuel processor 300 in separate streams, such as shown in dashed lines in FIG. 25. In FIG. 25, feed stream 316 is shown being delivered to fuel processor 300 by a feed stream delivery system 317. Delivery system 317 includes any suitable mechanism, device, or combination thereof that delivers the feed stream to fuel processor 300. For example, the delivery system may include one or more pumps that deliver the components of stream 316 from a supply. Additionally or alternatively, system 317 may include a valve assembly adapted to regulate the flow of the components from a pressurized supply. The supplies may be located external the fuel cell system, or may be contained within or adjacent the system.

As generally indicated at 332 in FIG. 25, fuel processor 300 includes a hydrogen-producing region in which mixed gas stream 40 is produced from feed stream 316. As discussed, a variety of different processes may be utilized in the hydrogen-producing region. An example of such a process is steam reforming, in which region 312 includes a steam reforming catalyst 334. As discussed, other hydrogen-producing mechanisms may be utilized without departing from the scope of the present disclosure. As discussed, in the context of a steam or autothermal reformer, mixed gas stream 40 may also be referred to as a reformate stream. The fuel processor may be adapted to produce substantially pure hydrogen gas, or even pure hydrogen gas. For the purposes of the present disclosure, substantially pure hydrogen gas may be greater than 90% pure, greater than 95% pure, greater than 99% pure, greater than 99.5% pure, or greater than 99.9% pure. Illustrative, non-exclusive examples of suitable fuel processors are disclosed in U.S. Pat. Nos. 6,221,117 and 6,319,306, incorporated above, and pending U.S. patent application Ser. No. 09/802,361, which was filed on Mar. 8, 2001, and is entitled “Fuel Processor and Systems and Devices Containing the Same,” which is hereby incorporated by reference in its entirety for all purposes.

Fuel processor 300 may, but does not necessarily, further include a polishing region 348, such as shown in FIG. 25. Polishing region 348 receives hydrogen-rich stream 48 from assembly 10 and further purifies the stream by reducing the concentration of, or removing, selected compositions therein. In FIG. 25, the resulting stream is indicated at 314 and may be referred to as a product hydrogen stream or purified hydrogen stream. When fuel processor 300 does not include polishing region 348, hydrogen-rich stream 48 forms product hydrogen stream 314. For example, when stream 48 is intended for use in a fuel cell stack, compositions that may damage the fuel cell stack, such as carbon monoxide and carbon dioxide, may be removed from the hydrogen-rich stream, if necessary. The concentration of carbon monoxide may be less than 10 ppm (parts per million) to prevent the control system from isolating the fuel cell stack. For example, the system may limit the concentration of carbon monoxide to less than 5 ppm, or even less than 1 ppm. The concentration of carbon dioxide may be greater than that of carbon monoxide. For example, concentrations of less than 25% carbon dioxide may be acceptable. For example, the concentration of carbon dioxide may be less than 10%, or even less than 1%. Concentrations of carbon dioxide may be less than 50 ppm. It should be understood that the concentrations presented herein are illustrative examples, and that concentrations other than those presented herein may be used and are within the scope of the present disclosure. For example, particular users or manufacturers may require minimum or maximum concentration levels or ranges that are different than those identified herein.

Region 348 includes any suitable structure for removing or reducing the concentration of the selected compositions in stream 48. For example, when the product stream is intended for use in a PEM fuel cell stack or other device that will be damaged if the stream contains more than determined concentrations of carbon monoxide or carbon dioxide, it may be desirable to include at least one methanation catalyst bed 350. Bed 350 converts carbon monoxide and carbon dioxide into methane and water, both of which will not damage a PEM fuel cell stack. Polishing region 348 may also include another hydrogen-producing region 352, such as another reforming catalyst bed, to convert any unreacted feedstock into hydrogen gas. In such an embodiment, the second reforming catalyst bed may be upstream from the methanation catalyst bed so as not to reintroduce carbon dioxide or carbon monoxide downstream of the methanation catalyst bed.

Steam reformers typically operate at temperatures in the range of 200° C. and 700° C., and at pressures in the range of 50 psi and 1000 psi, although temperatures outside of this range are within the scope of the present disclosure, such as depending upon the particular type and configuration of fuel processor being used. Any suitable heating mechanism or device may be used to provide this heat, such as a heater, burner, combustion catalyst, or the like. The heating assembly may be external the fuel processor or may form a combustion chamber that forms part of the fuel processor. The fuel for the heating assembly may be provided by the fuel-processing or fuel cell system, by an external source, or both.

In FIG. 25, fuel processor 300 is shown including a shell 312 in which the above-described components are contained. Shell 312, which also may be referred to as a housing, enables the components of the fuel processor to be moved as a unit. It also protects the components of the fuel processor from damage by providing a protective enclosure and reduces the heating demand of the fuel processor because the components of the fuel processor may be heated as a unit. Shell 312 may, but does not necessarily, include insulating material 333, such as a solid insulating material, blanket insulating material, or an air-filled cavity. It is within the scope of the present disclosure, however, that the fuel processor may be formed without a housing or shell. When fuel processor 300 includes insulating material 333, the insulating material may be internal the shell, external the shell, or both. When the insulating material is external a shell containing the above-described reforming, separation and/or polishing regions, the fuel processor may further include an outer cover or jacket external the insulation.

It is further within the scope of the present disclosure that one or more of the components of fuel processor 300 may either extend beyond the shell or be located external at least shell 312. For example, assembly 10 may extend at least partially beyond shell 312, as indicated in FIG. 24. As another example, and as schematically illustrated in FIG. 25, polishing region 348 may be external of shell 312 and/or a portion of hydrogen-producing region 332 (such as portions of one or more reforming catalyst beds) may extend beyond the shell.

As indicated above, fuel processor 300 may be adapted to deliver hydrogen-rich stream 48 or product hydrogen stream 314 to at least one fuel cell stack, which produces an electric current therefrom. In such a configuration, the fuel processor and fuel cell stack may be referred to as a fuel cell system. An example of such a system is schematically illustrated in FIG. 26, in which a fuel cell stack is generally indicated at 322. The fuel cell stack is adapted to produce an electric current from the portion of product hydrogen stream 314 delivered thereto. In the illustrated embodiment, a single fuel processor 300 and a single fuel cell stack 322 are shown and described, however, it should be understood that more than one of either or both of these components may be used. It should also be understood that these components have been schematically illustrated and that the fuel cell system may include additional components that are not specifically illustrated in the figures, such as feed pumps, air delivery systems, heat exchangers, heating assemblies and the like.

Fuel cell stack 322 contains at least one, and typically multiple, fuel cells 324 that are adapted to produce an electric current from the portion of the product hydrogen stream 314 delivered thereto. This electric current may be used to satisfy the energy demands, or applied load, of an associated energy-consuming device 325. Illustrative examples of devices 325 include, but should not be limited to, a motor vehicle, recreational vehicle, boat, tools, lights or lighting assemblies, appliances (such as a household or other appliance), household, signaling or communication equipment, etc. It should be understood that device 325 is schematically illustrated in FIG. 26 and is meant to represent one or more devices or collection of devices that are adapted to draw electric current from the fuel cell system. A fuel cell stack typically includes multiple fuel cells joined together between common end plates 323, which contain fluid delivery/removal conduits (not shown). Examples of suitable fuel cells include proton exchange membrane (PEM) fuel cells and alkaline fuel cells. Fuel cell stack 322 may receive all of product hydrogen stream 314. Some or all of stream 314 may additionally, or alternatively, be delivered, via a suitable conduit, for use in another hydrogen-consuming process, burned for fuel or heat, or stored for later use.

### INDUSTRIAL APPLICABILITY

The present disclosure, including fuel-processing systems, hydrogen-processing assemblies, fuel cell systems, and components thereof, is applicable to the fuel-processing and other industries in which hydrogen gas is produced and/or utilized.

In the event that any of the references that are incorporated by reference herein define a term in a manner or are otherwise inconsistent with either the non-incorporated disclosure of the present application or with any of the other incorporated references, the non-incorporated disclosure of the present application shall control and the term or terms as used therein only control with respect to the patent document in which the term or terms are defined.

The disclosure set forth above encompasses multiple distinct inventions with independent utility. While each of these inventions has been disclosed in a preferred form or method, the specific alternatives, embodiments, and/or methods thereof as disclosed and illustrated herein are not to be considered in a limiting sense, as numerous variations are possible. The present disclosure includes all novel and non-obvious combinations and subcombinations of the various elements, features, functions, properties, methods and/or steps disclosed herein. Similarly, where any disclosure above or claim below recites “a” or “a first” element, step of a method, or the equivalent thereof, such disclosure or claim should be understood to include one or more such elements or steps, neither requiring nor excluding two or more such elements or steps.

Inventions embodied in various combinations and subcombinations of features, functions, elements, properties, steps and/or methods may be claimed through presentation of new claims in a related application. Such new claims, whether they are directed to a different invention or directed to the same invention, whether different, broader, narrower, or equal in scope to the original claims, are also regarded as included within the subject matter of the present disclosure.

1. A hydrogen-processing assembly, comprising:
a hydrogen-separation region including at least one hydrogen-selective membrane, wherein the hydrogen-separation region is adapted to receive a mixed gas stream containing hydrogen gas and other gases and to separate the mixed gas stream into a permeate stream and a byproduct stream, wherein the permeate stream has at least one of a greater concentration of hydrogen gas and a lower concentration of the other gases than the mixed gas stream, and further wherein the byproduct stream contains at least a substantial portion of the other gases; and
an enclosure defining an internal volume including a mixed gas region and a permeate region separated by the hydrogen-separation region, the enclosure comprising:
a body portion including an opening and at least one flange extending adjacent the opening;
an end plate positioned at least partially within the opening and including an external surface, wherein the at least one flange engages the external surface of the end plate and retains the end plate within the opening;
a seal defining a fluid tight interface between the body portion and the end plate;
at least one input port through which a fluid stream is delivered to the enclosure;
at least one product output port through which the permeate stream is removed from the permeate region; and
at least one byproduct output port through which a byproduct stream is removed from the mixed gas region.

2. The assembly of claim 1,
wherein the fluid stream is the mixed gas stream containing hydrogen gas and other gases and is delivered to the mixed gas region;
wherein the at least one hydrogen-selective membrane includes a first surface adapted to be contacted by the mixed gas stream and a permeate surface generally opposed to the first surface; and
wherein the permeate stream is formed from a portion of the mixed gas stream that passes through the membrane to the permeate region of the internal volume.

3. The assembly of claim 1, wherein the assembly further comprises a hydrogen-producing region;
wherein the fluid stream is a feed stream and is delivered to the hydrogen-producing region;
wherein in the hydrogen-producing region, the feed stream is chemically reacted to produce hydrogen gas therefrom in the form of the mixed gas stream containing hydrogen gas and other gases, and wherein the mixed gas stream is delivered to the mixed gas region of the internal volume;
wherein the at least one hydrogen-selective membrane includes a first surface adapted to be contacted by the mixed gas stream and a permeate surface generally opposed to the first surface; and
wherein the permeate stream is formed from a portion of the mixed gas stream that passes through the membrane to the permeate region of the internal volume.

4. The assembly of claim 1, wherein the seal includes a weld.

5. The assembly of claim 1, wherein the seal includes a fillet weld between the at least one flange and the end plate.

6. The assembly of claim 1, wherein the seal includes a seal weld.

7. The assembly of claim 1, wherein the seal includes a lap weld between the at least one flange and the end plate.

8. The assembly of claim 1, wherein the fluid tight interface is free of groove welds.

9. The assembly of claim 1, wherein the seal includes a weld extending the entire length of the fluid tight interface, at least a portion of the weld including a fillet weld between the at least one flange and the end plate.

10. The assembly of claim 1, wherein the end plate includes a peripheral region corresponding to a perimeter of the opening.

11. The assembly of claim 10, wherein a portion of the peripheral region extends outside of the opening.

12. The assembly of claim 10, wherein no portion of the peripheral region extends outside of the opening.

13. The assembly of claim 1, wherein the opening includes three or more sides, and the at least one flange includes at least one flange extending adjacent each of the three or more sides of the opening.

14. The assembly of claim 1, wherein the at least one flange extends adjacent the opening within a plane generally parallel to the opening.

15. The assembly of claim 1, wherein the at least one flange extends adjacent the opening at an acute angle relative to an inside surface of an adjacent wall of the body portion.

16. The assembly of claim 1, wherein the at least one flange includes:
a first portion extending adjacent the opening at an obtuse angle relative to an inside surface of an adjacent wall of the body portion; and
a second portion extending from the first portion within a plane generally parallel to the opening.

17. The assembly of claim 1, wherein the at least one flange extends adjacent the opening at an obtuse angle relative to an inside surface of an adjacent wall of the body portion.

18. The assembly of claim 17, wherein the obtuse angle is in the range of 100 and 170 degrees.

19. The assembly of claim 1,
wherein the fluid stream is the mixed gas stream that is delivered to the mixed gas region;
wherein the hydrogen-separation region includes a plurality of spaced-apart hydrogen-selective membranes, each membrane having a first surface adapted to be contacted by at least a portion of the mixed gas stream and a permeate surface generally opposed to the first surface; and
wherein the permeate stream is formed from a portion of the mixed gas stream that passes through the membrane to the permeate region of the internal volume.

20. The assembly of claim 1,
wherein the fluid stream is a mixed gas stream containing gas and other gases and is delivered to the mixed gas region;
wherein the hydrogen-separation region includes at least one membrane envelope formed from a pair of hydrogen-selective membranes;
wherein each membrane includes a first surface adapted to be contacted by the mixed gas stream and a permeate surface generally opposed to the first surface;
wherein the pair of membranes are spaced apart from each other with their respective permeate surfaces generally facing each other to define the permeate region in the form of a harvesting conduit extending between the respective permeate surfaces; and
wherein the permeate stream is formed from at least a portion of the mixed gas stream that passes through the pair of hydrogen-selective membranes to the harvesting conduit, with at least a portion of the mixed gas stream that does not pass though the membranes forming at least a portion of the byproduct stream.

21. The assembly of claim 1, wherein the at least one flange compresses the hydrogen-separation region between the body portion and the end plate.

22. The assembly of claim 21, wherein the hydrogen-separation region includes a plurality of spaced-apart hydrogen-selective membranes, each membrane having a first surface adapted to be contacted by at least a portion of the mixed gas stream and a permeate surface generally opposed to the first surface.

23. The assembly of claim 1,
wherein the body portion further includes a second opening and at least a second flange extending adjacent the second opening;
wherein the enclosure further comprises:
a second end plate positioned at least partially within the second opening, wherein the at least a second flange engages the second end plate and retains the second end plate within the second opening; and
a second seal defining a fluid tight interface between the body portion and the second end plate.

24. The assembly of claim 23, wherein the first and second flanges compress the hydrogen separation region between the end plate and the second end plate.

25. The assembly of claim 1, in combination with a fuel cell stack adapted to receive at least a portion of the permeate stream.

26. The assembly of claim 1, in combination with a hydrogen-producing region adapted to produce the mixed gas stream to be delivered to the mixed gas region of the enclosure.

27. The assembly of claim 26, wherein the hydrogen-producing region includes at least one reforming catalyst bed.

28. The assembly of claim 27, wherein the hydrogen-producing region is external to the enclosure.

29. The assembly of claim 27, wherein the hydrogen-producing region is internal to the enclosure.

30. The assembly of claim 27, in further combination with a fuel cell stack adapted to receive at least a portion of the permeate stream and to produce an electric current therefrom.

31. A hydrogen-processing assembly, comprising
a hydrogen-producing region adapted to produce a mixed gas stream containing hydrogen gas and other gases from at least one feed stream, wherein hydrogen gas forms a majority component of the mixed gas stream;
a hydrogen-separation region including a membrane assembly with at least a plurality of spaced-apart hydrogen-selective membranes, each membrane having a first surface adapted to be contacted by at least a portion of the mixed gas stream and a permeate surface generally opposed to the first surface, wherein the membrane assembly is adapted to separate the mixed gas stream into a permeate stream and a byproduct stream, wherein the permeate stream has at least one of a greater concentration of hydrogen gas and a lower concentration of the other gases than the mixed gas stream, and further wherein the byproduct stream contains at least a substantial portion of the other gases; and
an enclosure defining an internal volume including a mixed gas region and a permeate region separated by the hydrogen-separation region, wherein the enclosure houses the hydrogen-producing region, the enclosure including:
a body portion including an opening and at least one flange extending adjacent the opening;
an end plate positioned at least partially within the opening wherein the at least one flange engages the end plate and retains the end plate within the opening, wherein the at least one flange compresses the hydrogen-separation region between the body portion and the end plate;
a seal securing the at least one flange to the end plate;
at least one input port through which at least one feed stream is delivered to the hydrogen-producing region;
at least one product output port through which the permeate stream is removed from the permeate region; and
at least one byproduct output port through which a byproduct stream is removed from the mixed gas region;
wherein in the hydrogen-producing region, the feed stream is chemically reacted to produce a mixed gas stream containing hydrogen gas and other gases, wherein hydrogen gas forms a majority component of the mixed gas stream, and further wherein the mixed gas stream is delivered to the mixed gas region of the internal volume.

32. The assembly of claim 31, wherein the seal forms a fluid tight interface between the body portion and the end plate.
